(19) United States
(12) Patent Application Publication
(10) Pub. No.: US 2007/0209193 A1
(43) Pub. Date: Sep. 13, 2007

(54) METHOD OF MANUFACTURING PERPENDICULAR MAGNETIC RECORDING HEAD IN WHICH MAGNETIC FIELD IS PERPENDICULARLY APPLIED TO RECORDING MEDIUM SUCH AS DISK TO PERFORM RECORDING OPERATION

(75) Inventor: Kiyoshi KOBAYASHI, Niigata-ken (JP)

Correspondence Address: BRINKS HOFER GILSON & LIONE, P.O. BOX 10395, CHICAGO, IL, 60610, US

(73) Assignee: ALPS ELECTRIC CO., LTD., Tokyo (JP)

(21) Appl. No.: 11/684,976

(22) Filed: Mar. 12, 2007

(30) Foreign Application Priority Data
Mar. 13, 2006 (JP) 2006-067721

(51) Int. Cl. G11B 5/127

(52) U.S. Cl. 29/603.13; 29/603.07

(57) ABSTRACT

A method is provided for manufacturing a perpendicular magnetic recording head having a shape in which a main magnetic pole layer and a sub-yoke layer are formed without a trimming operation. A neck height can be controlled with high precision, and a recording performance can be improved, whereby fringing is suppressed. Because the main magnetic pole layer and the sub-yoke layer are separately formed without the trimming operation, it is possible to easily manufacture the perpendicular magnetic recording head having a shape in which a neck height NH is determined with high precision, and the occurrence of the fringing is suppressed. Magnetic flux can be smoothly induced into the magnetic pole front end portion of the main magnetic pole layer.

This application claims the benefit of Japanese Patent Application No. 2006-067721 filed Mar. 13, 2006, which is hereby incorporated by reference.

### TECHNICAL FIELD

The present invention relates to a method of manufacturing a perpendicular magnetic recording head in which a magnetic field is perpendicularly applied to a medium surface of a recording medium, such as a disk, to perform a recording operation.

### BACKGROUND

The perpendicular magnetic recording head includes a main magnetic pole layer, a sub yoke layer overlapped in a height direction, a return yoke layer, and a coil layer.

A dimension of a surface of the main magnetic pole layer opposite to the recording medium is substantially smaller than that of a surface of the return yoke layer opposite to the recording medium. In this case, a leakage recording magnetic field is concentrated on a front end of the main magnetic pole layer and the recording medium is perpendicularly magnetized by the concentrated magnetic flux, whereby magnetic data is recorded in the recording medium. The magnetic flux passes through the recording medium and then, returns to the return yoke layer.

FIG. 19 is a plan view of a main magnetic pole layer and a sub-yoke layer constituting a perpendicular magnetic recording head in the prior art.

As shown in FIG. 19, a main magnetic pole layer 1 includes a front end portion 1a and a rear end portion 1b. The front end portion 1a is exposed to the opposite surface by a width Tw and is formed in an elongated shape in a height direction (Y direction shown in the drawing). The rear end portion 1b is connected to a trailing edge portion 1c of the front end portion 1a and a width in a track width direction is significantly larger than that of the front end portion 1a.

The sub-yoke layer 2 is a layer provided to induct a sufficient magnetic flux to the front end portion 1a of the main magnetic pole layer 1. The maximum size of the sub-yoke layer 2 in the track width direction is equal to or larger than the maximum width of the rear end portion 1b in the track width direction. The sub-yoke layer 2 is formed in a slope retreating in the height direction as a front end surface 2a that faces the opposite surface faces.

In the prior art shown in FIG. 19, the front end surface 2a of the sub-yoke layer 2 is retreated to a height side of the opposite surface, but the front end surface 2a is positioned closer to the opposite surface than the front end surface id that faces the opposite surface of the rear end portion 1b of the main magnetic pole layer 1.

JP-A-2005-93029 (US20050105215A1), JP-A-2004-185742 (US20040184191A1), and JP-A-2004-127406 (US20040061988A1) are examples of a background art.

However, in the structure of the prior art shown in FIG. 19, since the front end surface 2a of the sub-yoke layer 2 is closer to the opposite surface than a front end surface 1d of the rear end portion 1b, a leakage magnetic field occurs in a recording medium from the front end surface 2a of the sub-yoke layer 2, thereby causing fringing.

A neck height is determined by a position where the front end surface 2a of the sub-yoke layer 2 and the front end portion 1a of the main magnetic pole layer 1 are overlapped with each other, whereby a recording performance of the perpendicular magnetic recording head is destabilized. The neck height is a focusing position of the magnetic flux at the time when the magnetic flux is inducted from a rear side in the height direction of the front end portion 1a to the front end portion 1a. When the neck height is determined by the position of the front end surface 2a of the sub-yoke layer 2, a deviation of the neck height easily occurs, and the focusing of the magnetic flux is not smoothly performed, thereby adversely affecting the recording performance of the perpendicular magnetic recording head.

Accordingly, an aspect that the front end surface 2a of the sub-yoke layer 2 is retreated to the rear side in the height direction of the front end surface 1d of the rear end portion 1b of the main magnetic pole layer 1 may be considered. However, in this case, magnetic field intensity discharged to the recording medium from the front end portion 1a of the main magnetic pole layer 1 decreases, thereby lowering the recording performance.

For example, JP-A-2004-139663 (US20040061988A1) described above discloses a method of manufacturing the perpendicular magnetic recording head. In JP-A-2004-139663 (US20040061988A1), the neck height is referred to as a ‘flare point’. However, the flare point can be restricted in JP-A-2004-139663 (US20040061988A1) for any reason.

However, in the manufacturing method disclosed in JP-A-2004-139663 (US20040061988A1), since the flare point is formed by etching the main magnetic pole layer, it is considered that the deviation may easily occur. That is to say, in accordance with JP-A-2004-139663 (US20040061988A1), the main magnetic pole layer is etched while a layer formed on an upper side of the main magnetic pole layer serves as a mask, but the layer serving as the mask is also shaved, whereby the deviation of the flare point may easily occur. In JP-A-2004-139663 (US20040061988A1), since the sub-yoke layer is trimmed, an etching angle is adjusted or the layer serving as the mask is formed. Accordingly, a manufacturing process may be complicated.

### SUMMARY

It is an object of the present invention to provide a method of manufacturing a perpendicular magnetic recording head that has a shape in which an improvement in recording performance can be effectively obtained by restricting a neck height in high accuracy and suppressing a fringing.

According to an aspect of the invention, a method of manufacturing the perpendicular magnetic recording head includes the following steps.

The method of manufacturing a perpendicular magnetic recording head according to the above-mentioned aspect of the invention includes the steps of (a) coating a sub-yoke layer on a planarized surface, the sub-yoke layer having an elongated sub-yoke front end portion extending in a height direction from a position retreating from a surface opposite to a recording medium, and a sub-yoke rear end portion connected to a trailing edge portion of the sub-yoke front end portion. The sub-yoke rear end portion has a width in a track width direction larger than that of the sub-yoke front end portion, (b) burying the periphery of the sub-yoke layer with an insulating layer and planarizing a top surface of the sub-yoke layer and a top surface of the insulating layer; and (c) coating a main magnetic pole layer on the side-yoke layer and the insulating layer, where the main magnetic pole layer has an elongated magnetic pole front end portion exposed to the surfaces by a track width Tw and extending in the height direction, wherein the magnetic pole front end portion is overlapped with at least a part of the sub-yoke front end portion. The width of the magnetic pole front end portion is equal to or larger than the width of the sub-yoke front end portion, and the trailing edge portion of the magnetic pole front end portion is disposed at the same position as the sub-yoke front end portion or disposed closer to the opposite surfaces than the trailing edge portion of the sub-yoke front end portion. The neck height is controlled by the trailing edge portion of the magnetic pole front end portion.

The above-mentioned aspect of the invention is the method of forming the main magnetic pole layer on the sub-yoke layer. As shown in step (a), the sub-yoke layer is formed by the coating operation and the main magnetic pole layer is formed by the coating in step (c) after a planarizing operation in step (b). The trailing edge portion of the magnetic pole front end portion is disposed at the same position as the sub-yoke front end portion or disposed closer to the opposite surfaces than the trailing edge portion of the sub-yoke front end portion in a plan view, the neck height is controlled by the trailing edge portion of the magnetic pole front end portion, and the magnetic pole front end portion is overlapped with the sub-yoke front end portion. At this time, the width of the magnetic pole front end portion is equal to or larger than that of the sub-yoke front end portion. Since the main magnetic pole layer and the sub-yoke layer are separately formed without the trimming operation, it is possible to perform the control with high precision.

By the manufacturing process, it is possible to easily manufacture the perpendicular magnetic recording head that has a shape in which a neck height NH is determined with high precision by a trailing edge portion of a magnetic pole front end portion of a main magnetic pole layer and the occurrence of the fringing is suppressed, whereby a magnetic flux can be sufficiently and smoothly induced into the magnetic pole front end portion of the main magnetic pole layer.

It is preferable that in step (C), the entire front end surface that faces the opposite surface of the magnetic pole rear end portion is formed along the front end surface that faces the opposite surface of the sub-yoke rear end portion and is formed closer to the opposite surface than the front end surface of the sub-yoke rear end portion in a plan view. By this configuration, it is possible to manufacture a perpendicular magnetic recording head in which the occurrence of the fringing can be more suppressed.

It is preferable that the front end surface that faces the opposite surface of the sub-yoke front end portion, and the front end surface that faces the opposite surface of the sub-yoke front end portion, are formed in a slope inclined about the height direction as they go from the top surface to a bottom surface, in step (a). More specifically, it is preferable that prior to step (a), the insulating layer is formed at locations on the planarized surface other than the location where the sub-yoke layer is formed in step (a), and the rear end surface that faces the front end surface of the sub-yoke front end portion on the insulating layer, and the rear end surface that faces the front end surface of the sub-yoke rear end portion being formed in the slope inclined about the height direction from the top surface to the bottom surface, and a pattern surrounded with the insulating layer is coated with the sub-yoke layer in step (a) and only the planarizing operation is performed in step (b). By this configuration, it is possible to manufacture a perpendicular magnetic recording head in which the occurrence of the fringing can be more effectively prevented and the magnetic flux can be smoothly induced into the magnetic pole front end portion of the main magnetic pole layer.

According to another aspect of the invention, a method of manufacturing a perpendicular magnetic recording head includes the following steps.

The method of a perpendicular magnetic recording head according to the above-mentioned aspect of the invention includes the steps of (d) coating a main magnetic pole layer on a planarized surface, the main magnetic pole layer having an elongated magnetic pole front end portion exposed to a surface opposite to a recording medium by a track width Tw and extending in a height direction and a magnetic pole rear end portion connected to a trailing edge portion of the magnetic pole front end portion and having a width in a track width direction larger than that of the magnetic pole front end portion, wherein the neck height is controlled in accordance with the position of the trailing edge portion of the magnetic pole front end portion; and (e) coating a sub-yoke layer on the main magnetic pole layer, the sub-yoke layer that has an elongated sub-yoke front end portion extending in a height direction from a position retreating in the height direction from the opposite surface and a sub-yoke rear end portion connected to the trailing edge portion of the sub-yoke front end portion and having a width in the track width direction larger than that of the sub-yoke front end portion, wherein at least a part of the sub-yoke front end portion is overlapped with the magnetic pole front end portion, and the width of the sub-yoke front end portion is equal to or smaller than the width of the magnetic pole front end portion, and the trailing edge portion of the sub-yoke front end portion is disposed at the same position as the magnetic pole front end portion or disposed at a position retreating from the trailing edge portion of the magnetic pole front end portion in the height direction in a plan view.

The above-mentioned aspect of the invention is a method of forming the sub-yoke layer on the main magnetic pole layer. As shown in step (d), the main magnetic pole layer is formed by the coating operation and the sub-yoke layer is formed by the coating operation in step (e). The trailing edge portion of the sub-yoke front end portion is disposed at the same position as the magnetic pole front end portion or disposed at a position retreating from the trailing edge portion of the magnetic pole front end portion in the height direction in a plan view. The neck height is controlled by the trailing edge portion of the magnetic pole front end portion and at least a part of the sub-yoke front end portion is overlapped with the main magnetic pole front end portion. At this time, the width of the sub-yoke front end portion is equal to or smaller than that of the main magnetic pole front end portion. Since the main magnetic pole layer and the sub-yoke layer are separately formed without the trimming operation, it is possible to perform the control with high precision.

By the manufacturing process, it is possible to easily manufacture the perpendicular magnetic recording head that has a shape in which a neck height NH is determined with high precision by a trailing edge portion of a magnetic pole front end portion of a main magnetic pole layer and the occurrence of the fringing is suppressed, whereby a magnetic flux can be sufficiently and smoothly induced into the magnetic pole front end portion of the main magnetic pole layer.

In this case, the sub-yoke layer may be formed of a lift-off resist layer by a sputtering method in step (e). By this configuration, it is possible to form the sub-yoke layer without the trimming operation. In this case, since the front end surface that faces the opposite surface of the sub-yoke front end portion and the front end surface that faces the opposite surface of the sub-yoke front end portion are formed in a slope inclined about the height direction as they go from the top surface to a bottom surface, in step (a), it is possible to manufacture a perpendicular magnetic recording head in which the occurrence of the fringing can be more effectively prevented and the magnetic flux can be more sufficiently and smoothly induced into the magnetic pole front end portion of the main magnetic pole layer.

It is preferable that an entire front end surface that faces the opposite surface of the sub-yoke rear end portion is formed along the front end surface facing the opposite surface of the magnetic pole rear front end portion or by being retreated closer to the height than the front end surface of the magnetic pole rear end portion in a plan view, in step (e). By this configuration, it is possible to manufacture the perpendicular magnetic recording head in which the occurrence of the fringing can be suppressed.

It is preferable that the main magnetic pole layer is formed of a magnetic material that has a saturation magnetic flux density higher than the sub-yoke layer, and the sub-yoke layer is formed of a magnetic material that has a magnetic permeability higher than the main magnetic pole layer. By this configuration, since the magnetic flux can be induced into the magnetic pole front end portion of the main magnetic pole layer and the magnetic saturation in the magnetic pole front end portion can be suppressed, it is possible to easily manufacture the perpendicular magnetic recording head that has a high recording performance.

Since the main magnetic pole layer and the sub-yoke layer are separately formed without the trimming operation, it is possible to easily manufacture the perpendicular magnetic recording head that has a shape in which in which the neck height is determined with high precision by the trailing edge portion of the magnetic pole front end portion of the main magnetic pole layer and the occurrence of the fringing is suppressed, whereby a magnetic flux can be sufficiently and smoothly induced into the magnetic pole front end portion of the main magnetic pole layer.

### DRAWING

FIG. 1 is a partial cross-sectional view of a perpendicular magnetic recording head taken along a line parallel to a film thickness direction (Z direction shown in the drawing) in a height direction (Y direction shown in the drawing).

FIG. 2 is a partial plan view of a main magnetic pole layer and a sub-yoke layer that constitutes a perpendicular magnetic recording head shown in FIG. 1.

FIG. 3 is a partial plan view of a main magnetic pole layer and a sub-yoke layer that constitutes a perpendicular magnetic recording head according to an embodiment other than that of FIG. 2.

FIGS. 4A, 4B, 4C, and 4D are partial cross-sectional views of main magnetic pole layers and partial cross-sectional views of main magnetic pole layers and sub-yoke layers according to different embodiments taken along a line parallel to a film thickness (Z direction shown in the drawing) in a height direction (Y direction shown in the drawing).

FIG. 5 is a process view that illustrates a method of manufacturing a perpendicular magnetic recording head of FIG. 4A.

FIG. 6 is a process view performed after a process of FIG. 5.

FIG. 7 is a process view performed after a process of FIG. 6.

FIG. 8 is a process view performed after a process of FIG. 7.

FIG. 9 is a process view performed after a process of FIG. 8.

FIG. 10 is a process view performed after a process of FIG. 9.

FIG. 11 is a process view that illustrates a method of manufacturing a perpendicular magnetic recording head of FIG. 4B.

FIG. 12 is a process view performed after a process of FIG. 11.

FIG. 13 is a process view that illustrates a method of manufacturing a perpendicular magnetic recording head of FIG. 4C.

FIG. 14 is a process view performed after a process of FIG. 13.

FIG. 15 is a process view performed after a process of FIG. 14.

FIG. 16 is a process view performed after a process of FIG. 15.

FIG. 17 is a process view performed after a process of FIG. 16.

FIG. 18 is a process view that illustrates a method of manufacturing a perpendicular magnetic recording head of FIG. 4D.

FIG. 19 is a partial plan view of a perpendicular magnetic recording head in prior art.

### DETAILED DESCRIPTION

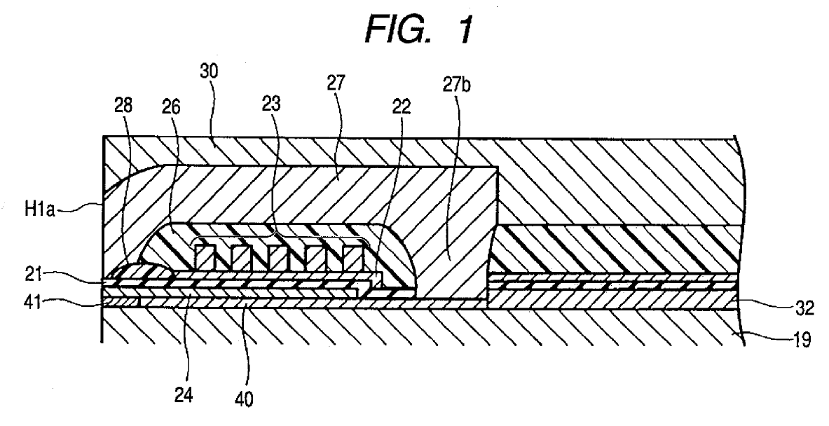

Hereinafter, a method of manufacturing a main magnetic pole layer 24 and a sub-yoke layer 40 in a perpendicular magnetic recording head will be primarily described. First the structure of the perpendicular magnetic recording head including the main magnetic pole layer 24 and the sub-yoke layer 40 will be described with reference to FIGS. 1 to 4,

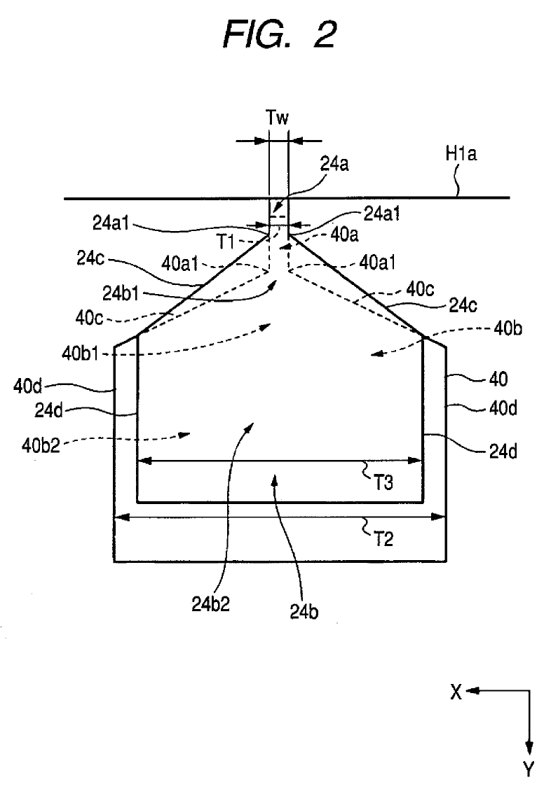

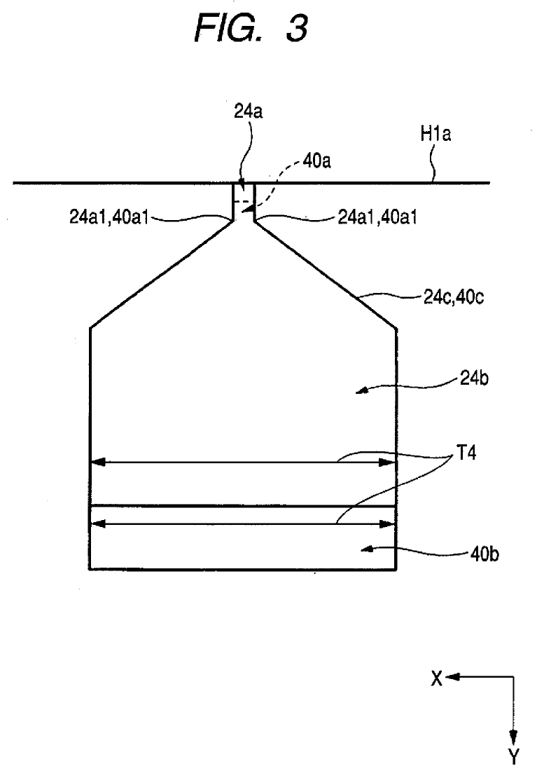

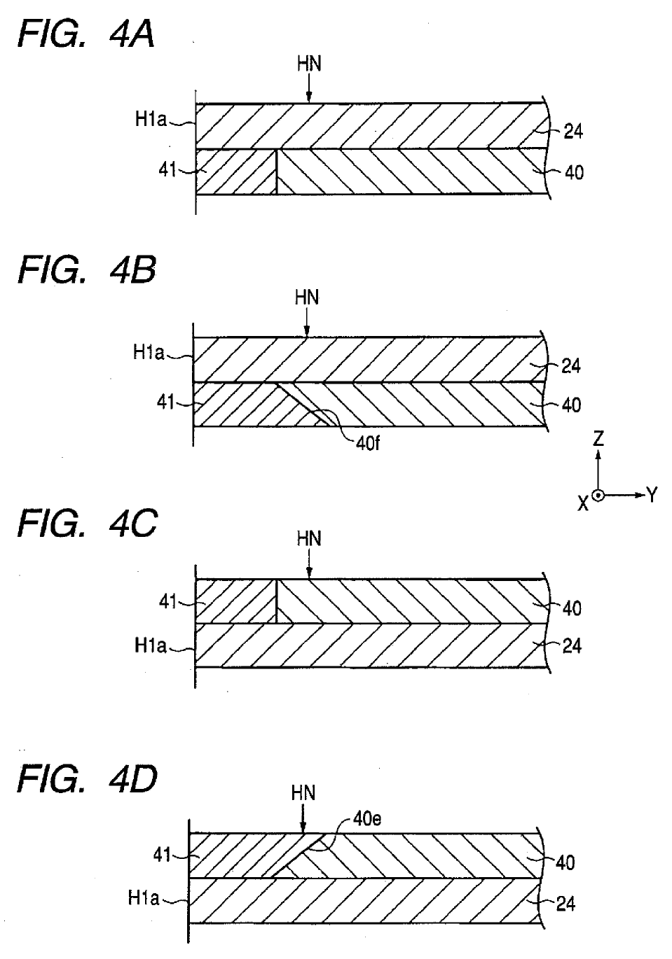

FIG. 1 is a partial cross-sectional view of a perpendicular magnetic recording head as seen from a direction parallel to a film thickness direction (Z direction shown in the drawing) in a height direction (Y direction shown in the drawing). FIG. 2 is a partial plan view of a main magnetic pole layer and a sub-yoke layer that constitutes the perpendicular magnetic recording head shown in FIG. 1. FIG. 3 is a partial plan view that constitutes the main magnetic pole layer and the sub-yoke layer that constitutes a perpendicular magnetic recording head according to an embodiment other than that of FIG. 2. FIGS. 4A, 4B, 4C, and 4D are partial cross-sectional views of main magnetic pole layers and sub-yoke layers according to different embodiments as seen from a direction parallel to a film thickness (Z direction shown in the drawing) in a height direction (Y direction shown in the drawing).

In the drawings, the X direction is defined as a track width direction, the Y direction is defined as a height direction, and the Z direction is defined as a film thickness direction. Each direction is orthogonal to the other two directions.

As shown in FIG. 1, a top surface of an insulating layer 19 formed on a slider (not shown) formed of a planarized surface. A coating base layer (not shown) is on the top surface, and the sub-yoke layer 40 is formed on the coating base layer. A regenerating head may be provided between the slider and the insulating layer 19. As shown in FIG. 2, the sub-yoke layer 40 has a width of T1 in the track width direction (X direction shown in the drawing) and includes an elongated sub-yoke front end portion 40a extending in the height direction (Y direction shown in the drawing), and a sub-yoke rear end portion 40b connected to a rear end portion 40a1 of the sub-yoke front end portion 40a and having a width in the track width direction (Z direction shown in the drawing) larger than the sub-yoke front end portion 40a. The sub-yoke front end portion 40a is formed at a position retreating in the height direction from an opposite surface H1a. As shown in FIG. 2, the sub-yoke rear end portion 40b includes an area 40b1 located in a side connected to the sub-yoke front end portion 40a and having a width in the track width direction slowly increasing in the height direction and an area 40b2 located in a rear side of the height direction of the area 40b1 and having a constant width T2 in the height direction. Accordingly, a front end surface 40c that faces the opposite surface H1a of the sub-yoke rear end portion 40b is formed in a slope slowly retreating on the height direction toward both end surfaces 40d located on both sides of the track width direction of the sub-yoke rear end portion 40b from the rear end portion 40a1 of the sub-yoke front end portion 40a. The both end surfaces 40d are formed in a direction parallel to the height direction.

The periphery of the sub-yoke layer 40 is buried with the insulating layer 41. The top surface of the sub-yoke layer 40 and the top surface of the insulating layer 41 are formed of the same plane.

A main magnetic pole layer 24 is formed on the sub-yoke layer 40 and the insulating layer 41. As shown in FIG. 2, the main magnetic pole layer 24 includes an elongated magnetic pole front end portion 24a exposed on the opposite surface H1a by a track width Tw and extending in the height direction, and a magnetic pole rear end portion 24b connected to a trailing edge portion 24a1 of the magnetic pole front end portion 24a and having a width in the track width direction (X direction shown in the drawing) larger than the magnetic pole front end portion 24a. As shown in FIG. 2, the magnetic pole rear end portion 24b includes an area 24b1 located in a side connected to the magnetic pole front end portion 24a and having a width in the track width direction slowly increasing in the height direction and an area 24b2 located in a rear side of the height direction of the area 24b1 and having a constant width T3 in the height direction. Accordingly, a front end surface 24c that faces the opposite surface H1a of the magnetic pole rear end portion 24b is formed in a slope slowly retreating on the height direction toward both end surfaces 24d located on both sides of the track width direction of the magnetic pole rear end portion 24b from the rear trailing edge portion 24a1 of the magnetic pole front end portion 24a. The both end surfaces 24d are formed in a direction parallel to the height direction.

As shown in FIG. 1, a gap layer 21 made of an inorganic material such as alumina or SiO₂ is formed on the main magnetic pole layer 24.

As shown in FIG. 1, a coil layer 23 is formed on the gap layer 21 with a coil insulating base layer 22 interposed therebetween. A coil insulating layer 26 made of an inorganic insulating material such as Al₂O₃ or an organic insulating material such as a resist is formed on the coil layer 23. In the embodiment shown in FIG. 1, a Gd crystal layer 28 made of an inorganic or organic material is formed on the gap layer 21. A leading edge of the Gd crystal layer 28 is formed at a location spaced apart from the opposite surface H1a in the height direction by a predetermined distance (gap depth).

A return yoke layer 27 made of a ferromagnetic material such as permalloy is formed from the gap layer 21 to the Gd crystal layer 28 and the coil insulating layer 26. As shown in FIG. 1, a rear end portion in the height direction of the return yoke layer 27 is formed of a connection portion 27b magnetically connected to the sub-yoke layer 40. The return yoke layer 27 may serve as a shield without a magnetic connection. As shown in FIG. 1, the return yoke layer 27 is covered with a protective layer 31 made of an inorganic insulating material.

As shown in FIG. 2, the trailing edge portion 24a1 of the magnetic pole front end portion 24a is disposed closer to the opposite surface H1a than the trailing edge portion 40a1 of the sub-yoke front end portion 40a in a plan view. As described by an after-mentioned manufacturing method, in the present embodiment, the main magnetic pole layer 24 is formed by a frame coating method (method of performing a frame and a dummy coat by manufacturing the frame of a removal pattern of the main magnetic pole layer 24 and coating a dummy part within the removal pattern and outside the frame) or a pattern coating method (method of removing the resist by forming the removal pattern on the resist and coating the removal pattern). That is to say, the main magnetic pole layer 24 is not formed by a trimming operation represented by an etching operation. In the etching operation, a deviation of the trailing edge portion 24a1 may easily occur due to an etching accuracy, but in the present embodiment, it is possible to control the position of the trailing edge portion 24a1 of the magnetic pole front end portion 24a. In the embodiment shown in FIG. 2, it is possible to control a neck height at the position of the trailing edge portion 24a1 of the magnetic pole front end portion 24a.

As shown in FIG. 2, the entire front end surface 40c of the sub-yoke rear end portion 40b of the sub-yoke layer 40 retreats closer to the height direction than the front end surface 24c of the magnetic pole rear end portion 24b of the main magnetic pole layer 24. That is to say, as shown in FIG. 2, the front end surface 40c of the sub-yoke rear end portion 40b does not protrude closer to the opposite surface H1a than the front end surface 24c of the magnetic pole rear end portion 24b in a plan view. Accordingly, it is possible to prevent a fringing from occurring.

In the embodiment shown in FIG. 2, a part of the sub-yoke front end portion 40a of the sub-yoke layer 40 is overlapped with the magnetic pole front end portion 24a of the main magnetic pole layer 24. At this time, since both end surfaces in the track width direction (X direction shown in the drawing) of the sub-yoke front end portion 40a is formed along the both end surfaces of the magnetic pole front end portion 24a in a plan view (or both end surfaces of the sub-yoke front end portion 40a may be located on an inner side of the both end surfaces of the magnetic pole front end portion 24a), it is possible to suppress the fringing from the sub-yoke front end portion 40a and smoothly focus a sufficient amount of magnetic field into the magnetic pole front end portion 24a. Therefore, it is possible to increase a magnetic field intensity applied from the magnetic pole front end portion 24a. As the result, the perpendicular magnetic recording head of the present embodiment has an excellent recording performance.

As shown in FIG. 3, the trailing edge portion 24a1 of the magnetic pole front end portion 24a of the main magnetic pole layer 24 and the trailing edge portion 40a1 of the sub-yoke front end portion 40a of the sub-yoke layer 40 may be formed at the same position, and the front end surface of the sub-yoke rear end portion 40b of the sub-yoke layer 40 may be formed along the front end surface 24c of the magnetic pole rear end portion 24b of the main magnetic pole layer 24. In FIG. 3, the magnetic pole rear end portion 24b of the main magnetic pole layer 24 and the sub-yoke rear end portion 40b of the sub-yoke layer 40 have the same width T4.

In embodiments shown in FIGS. 1 to 3, the sub-yoke layer 40 is formed on the main magnetic pole layer 24 and a cross section shape is formed as shown in FIG. 4A, but another cross section shape may be formed by an after-mentioned manufacturing method. Each of cross sections shown in FIGS. 4A to 4D is a cross section take along the same direction as the direction of FIG. 1.

An arrow ‘NH’ shown in FIGS. 4A to 4D represents the position of the neck height. The plane shapes of the main magnetic pole layer 24 and the sub-yoke layer 40 shown in FIGS. 4A to 4D are shown in FIG. 2. The cross section shapes shown in FIGS. 4A to 4D are shapes of the main magnetic pole layer 24 and the sub-yoke layer 40 seen in a direction parallel to a film thickness direction from a center position of the track width direction (X direction shown in the drawing) to the height direction.

In FIG. 4B, the main magnetic pole layer 24 is formed on the sub-yoke layer 40 similar to FIG. 4A. The front end surface 40f of the sub-yoke layer 40 is formed in the slope slowly retreating from the top surface to the bottom surface unlike FIG. 4A. That is to say, the front end surface 40f of the sub-yoke layer 40 is formed in the slope slowly retreating in the height direction as being spaced apart from the main magnetic pole layer 24. Herein, the front end surface 40f is the front end surface of the sub-yoke front end portion 40a of the sub-yoke layer 40 and the front end surface 40f is shown even on the front end surface 40c of the sub-yoke rear end portion 40b.

As shown in FIG. 4B, since a front end surface 40e of the sub-yoke layer 40 is formed in the slope slowly retreating in the height direction as being spaced apart from the sub-yoke layer 40, it is possible to prevent the fringing on the front end surface 40f from occurring and to smoothly induce the magnetic flux to the main magnetic pole layer 24. Therefore, it is possible to improve the recording performance.

In FIG. 4C, the sub-yoke layer 40 is formed on the main magnetic pole layer 24. The insulating layer 41 is buried between the sub-yoke layer 40 and the opposite surface H1a. The top surface of the sub-yoke layer 40 and the top surface of the insulating layer 41 are formed of the same planarized surface.

In FIG. 4D, the sub-yoke layer 40 is formed on the main magnetic pole layer 24 similar to FIG. 4C, but the front end surface 40e of the sub-yoke layer 40 is formed in the slope slowly retreating in the height direction from the bottom surface to the top surface unlike FIG. 4C. That is to say, the front end surface 40e of the sub-yoke layer 40 is formed in the slope slowly retreating in the height direction as being spaced apart from the main magnetic pole layer 24. Herein, the front end surface 40e is the front end surface of the sub-yoke front end portion 40a of the sub-yoke layer 40 and the front end surface 40e formed in the slope is shown even on the front end surface 40c of the rear end portion 40b.

As shown in FIG. 4D, since the front end surface 40e of the sub-yoke layer 40 is formed in the slope slowly retreating in the height direction as being spaced apart from the sub-yoke layer 40, it is possible to prevent the fringing on the front end surface 40e from occurring and to smoothly induce the magnetic flux to the main magnetic pole layer 24. Therefore, it is possible to improve the recording performance.

It is possible to easily manufacturing all perpendicular magnetic recording heads shown in FIGS. 4A to 4D by a method of manufacturing the perpendicular magnetic recording head described below. In the method of manufacturing the perpendicular magnetic recording head according the present embodiment, it is possible to form the neck height NH by the main magnetic pole layer 24 and to determine the position of the neck height NH in high accuracy. It is possible to suppress the fringing from occurring and to control the shape of the sub-yoke layer 40 or the positional relationship with the main magnetic pole layer 24 so as to smoothly supply a sufficient magnetic field to the main magnetic pole layer 24.

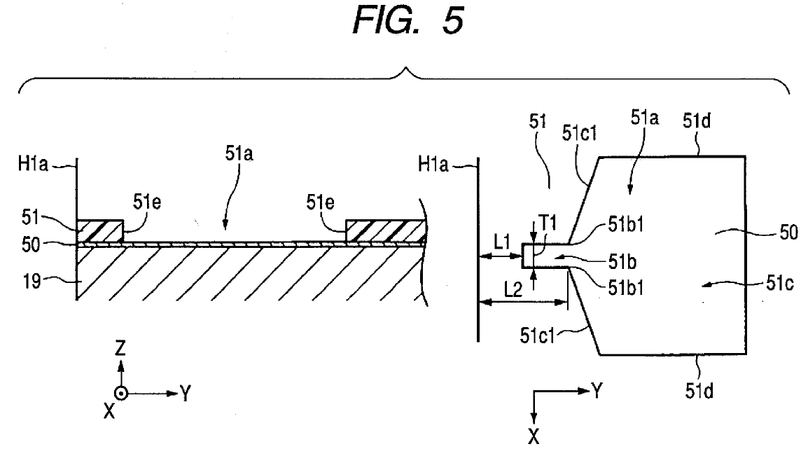

First, the method of manufacturing the perpendicular magnetic recording head shown in FIGS. 1, 2, and 4A will be described. Hereinafter, the method of manufacturing the main magnetic pole layer 24 and the sub-yoke layer 40 will be primarily described. In FIGS. 5 to 10, left figures are partial cross-sectional views (cross-sectional view taken along the same direction as the direction of FIG. 1 or FIG. 4) of the perpendicular magnetic recording head during the manufacturing process The right-hand figures are partial plan views of the perpendicular magnetic recording head during the manufacturing process. In the method of manufacturing the perpendicular magnetic recording head, an area closer to a front side than the surface H1a opposite to the recording medium (for example, the dummy pattern and a series of dummy patterns are formed in the front area at the time when the main magnetic pole layer 24 is formed) is actually coated, and the front area is removed by performing a cutting operation along the opposite surface H1a. In the following description of the manufacturing method, the front area will not be particularly described.

In a process shown in FIG. 5, an entire planarzied surface of the insulating layer 19 shown in FIG. 1 is sputter-coated with the coating base layer 50 made of a magnetic material such as NiFe. Next, the resist layer 51 is applied onto the entire surface on the coating base layer 50 and the removal pattern 51a of the sub-yoke layer 40 is formed on the resist layer 51 by an exposure phenomenon.

As shown in the right figure of FIG. 5, the removal pattern 51a is formed in the height direction from a position spaced apart from the opposite surface H1a to the height direction (Y direction shown in the drawing) by a predetermined distance L1. Since the removal pattern 51a has the same shape as the sub-yoke layer 40 shown in FIG. 2, an elongated front end portion 51b is formed in the removal pattern 51a, and a rear end portion 51c having a width in the track width direction (X direction shown in the drawing) larger than the front end portion 51b is formed in a rear side in the height direction of the front end portion 51b, as shown in FIG. 5. A wall surface 51e of the resist layer 51 is formed along a direction (Z direction shown in the drawing) perpendicular to the planarized surface (X-Y plane shown in the drawing).

In the process shown in FIG. 5, when the removal pattern 51a is formed, the removal pattern 51a is formed at the position spaced apart from the opposite surface H1a by the distance L1 in the height direction (Y direction shown in the drawing) and a distance L2 between a trailing edge portion 51b1 of the front end portion 51b of the removal pattern 51a and the opposite surface H1a is controlled. A width T1 of the front end portion 51b is equal to or smaller than a width (=track width Tw) of the magnetic pole front end portion 24a of the main magnetic pole layer 24 manufactured in a post-process. The entire front end portion 51b may not be formed in a constant width, that is to say, the entire front end portion 51b may be formed in a width slowly increasing in the height direction. As shown in FIG. 5, it is preferable that the front end surface 51c1 facing the opposite surface H1a of the rear end portion 51c of the removal pattern 51a is formed in the slope slowly retreating in the height direction (Y direction shown in the drawing) from the a center of the width direction to a side end surface 51d. Since the side end surface 51d is formed in a direction parallel to the height direction in FIG. 5, the rear end portion 51c has a constant width in an area to which the side end surface 51d is opposed in the width direction, but it may have a width slowly increasing as it goes to the height direction in an area to which the side end surface 51d is opposed.

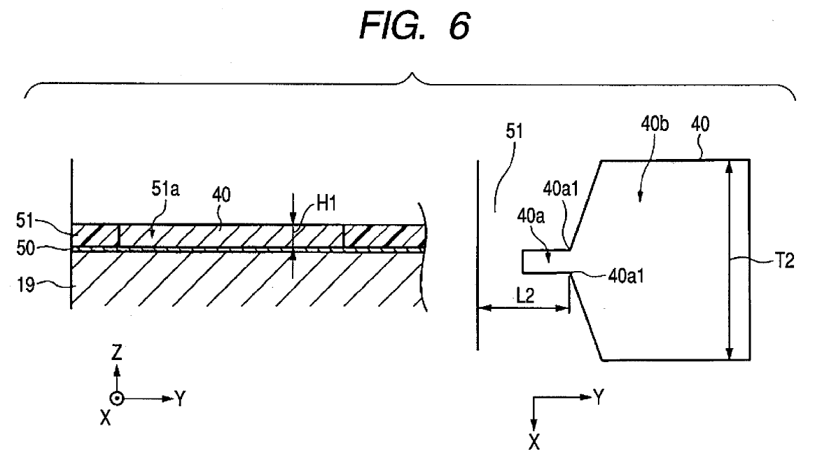

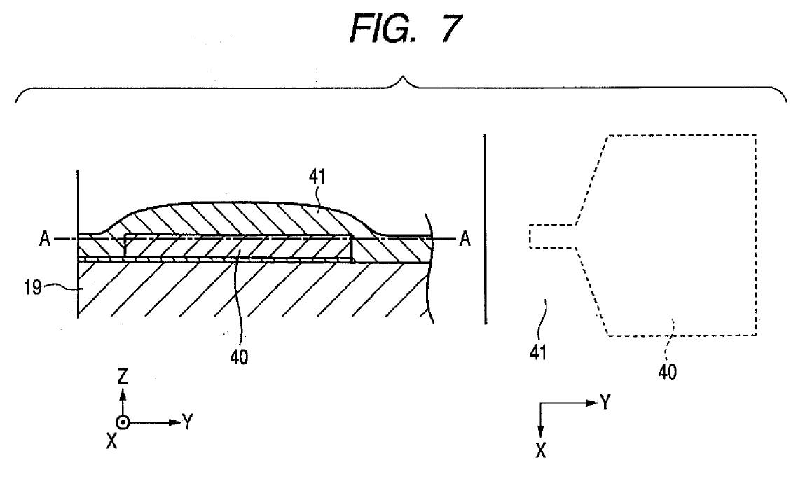

Next, in a process shown in FIG. 6, the coating base layer 50 exposed from the removal pattern 51a is coated with a sub-yoke layer 40. It is preferable that the sub-yoke layer 40 is formed of the magnetic material that has a magnetic permeability higher than the main magnetic pole layer 24 to be formed later. It is preferable that the sub-yoke layer 40 has a film thickness H2 larger than a film thickness H1 of the main magnetic pole layer 24 to be manufactured later. Since the film thickness H1 of the sub-yoke layer 40 is decreased through a planarization process of FIG. 7 rather than a coating operation in the process of FIG. 6, it is necessary to adjust the film thickness H1 in the coating step of FIG. 6 by anticipating the decreased film thickness. Since the sub-yoke layer 40 serves to induce a sufficient amount of magnetic flux to the main magnetic pole front end portion 24a of the main magnetic pole layer 24, it becomes possible to supply the sufficient amount of magnetic flux to the main magnetic pole front end portion 24a by forming the sub-yoke layer 40 in the high magnetic permeability and the large film thickness H1. The sub-yoke layer 40 is formed in the same shape as the removal pattern 51a by coating as shown in FIG. 2. That is to say, the sub-yoke layer 40 includes an elongated sub-yoke front end portion 40a extending in the height direction at a position spaced apart from the opposite surface H1a in the height direction and a sub-yoke rear end portion 40b formed in the rear side of the height direction of the sub-yoke front end portion 40a and having a width T2 larger than the sub-yoke front end portion 40a. The trailing edge portion 40a1 of the sub-yoke front end portion 40a is formed at a position spaced in the height direction (Y direction shown in the drawing) from the opposite surface H1a by L2. The width T1 of the sub-yoke front end portion 40a is equal to or smaller than the width (=track width Tw) of the magnetic pole front end portion 24a of the main magnetic pole layer 24.

The resist layer 51 is removed and the other coating base layer 50 below the sub-yoke layer 40 is removed by etching.

In a process shown in FIG. 7, an insulating layer 41 is formed on the sub-yoke layer 40 and the insulating layer 19 extending around the sub-yoke layer by a deposition method such as a sputtering method. The insulating layer 41 is made of an inorganic insulating material such as Al₂O₃ or SiO₂.

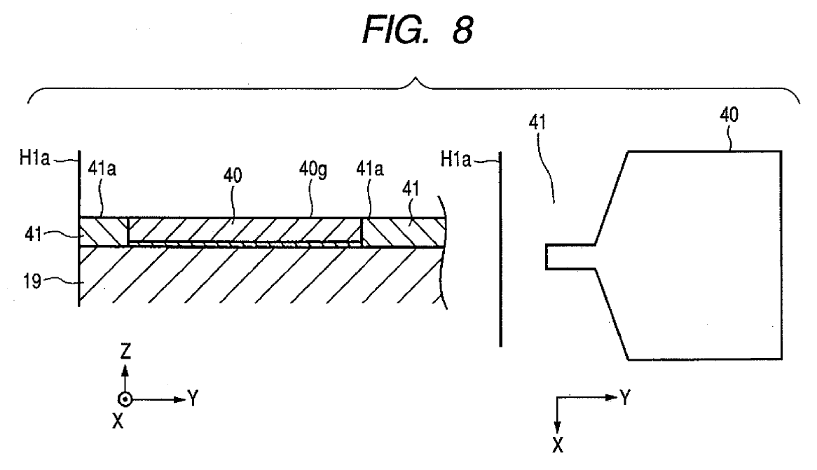

The sub-yoke layer 40 and the insulating layer 41 is planarized to a position of a line A-A by using a CMP technology. As shown in FIG. 8, a top surface 40g of the sub-yoke layer 40 and a top surface 41a of the insulating layer 41 are formed of the same planarized surface.

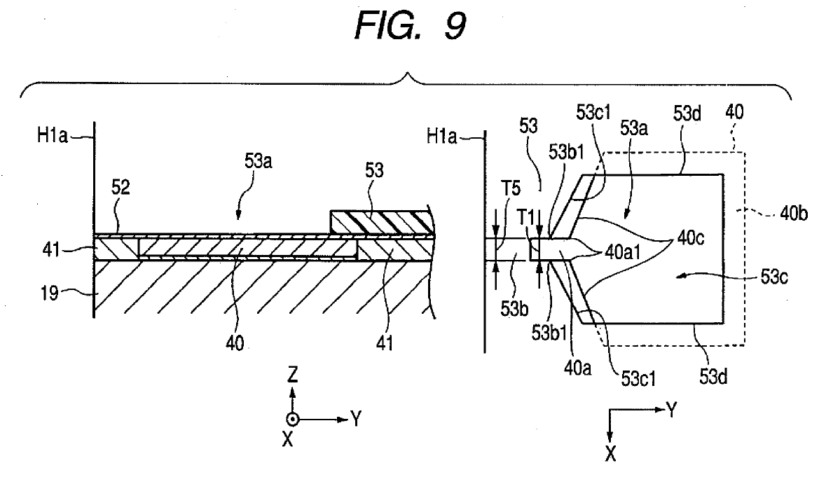

Next, in a process shown in FIG. 9, a coating base layer 52 made of a NiFe alloy is formed on the entire surface on the sub-yoke layer 40 and the entire surface on the insulating layer 41 by the sputtering method and the resist layer 53 is applied onto the coating base layer 52. When the main magnetic pole layer 24 formed later is overlapped only with the sub-yoke layer 40, it is not necessary that the coating base layer 52 is formed so that the top surface of the sub-yoke layer 40 serves as the coating base layer. However, in the present embodiment, since the main magnetic pole layer 24 partially protrudes onto the sub-yoke layer 40 and the insulating layer 41, the insulating layer 41 is also coated with the coating base layer 52.

As shown in FIG. 9, the removal pattern 53a of the main magnetic pole layer 24 is formed on the resist layer 53 by the exposure phenomenon. The removal pattern 53a is formed in the height direction (Y direction shown in the drawing) from the opposite surface H1a. Since the removal pattern 53a has the same shape as the main magnetic pole layer 24 shown in FIG. 2, an elongated front end portion 53b is formed in the removal pattern 53a, and a rear end portion 53c having a width in the track width direction (X direction shown in the drawing) larger than the front end portion 53b is formed in a rear side in the height direction of the front end portion 53b, as shown in a left figure of FIG. 9.

In a process shown in FIG. 9, when the removal pattern 53a is formed, the rear trailing edge 53b1 of the front end portion 53b of the removal pattern 53a is controlled to be formed at the same position as the trailing edge portion 40a1 of the sub-yoke front end portion 40a of the sub-yoke layer 40, or at a position closer to the opposite to H 1a than the trailing edge portion 40a1. The position of the trailing edge portion 53b1 becomes the same as the position of the neck height NH at the time of forming the main magnetic pole layer 24, it is necessary to perform a positioning operation in high accuracy. Accordingly, as shown in FIG. 9, it is preferable that the trailing edge portion 53b1 of the front end portion 53b of the removal pattern 53a is positioned closer to the opposite surface H1a than the trailing edge portion 40a1 of the sub-yoke front end portion 40a of the sub-yoke layer 40 since it is possible to easily perform the positioning operation. A width T5 of the front end portion 53b is equal to or smaller than the width T1 of the sub-yoke layer front end portion 40a of the sub-yoke layer 40. Since the width T5 of the front end portion 53b is a track width Tw and the track width is previously determined, it is preferable to control the width at the time when the sub-yoke layer 40 is formed. That is to say, the removal pattern 51a in the process shown in FIG. 5 is formed so that the width T1 of the sub-yoke front end portion 40a of the sub-yoke layer 40 is equal to or smaller than the track width Tw. As shown in FIG. 9, the front end surface 53c1 facing the opposite surface H1a of the rear end portion 53c of the removal pattern 53a is formed in the slope slowly retreating in the height direction (Y direction shown in the drawing) from the center of the width direction to a side end surface 53d. It is preferable that the entire front end surface 53c1 is positioned closer to the opposite surface H1a than the front end surface 40c of the sub-yoke rear end portion 40b of the sub-yoke layer 40. However, a part adjacent to a side end surface 53d of the front end surface 53c1 may be positioned closer to the height side of the front end surface 40c of the sub-yoke rear end portion 40b of the sub-yoke layer 40.

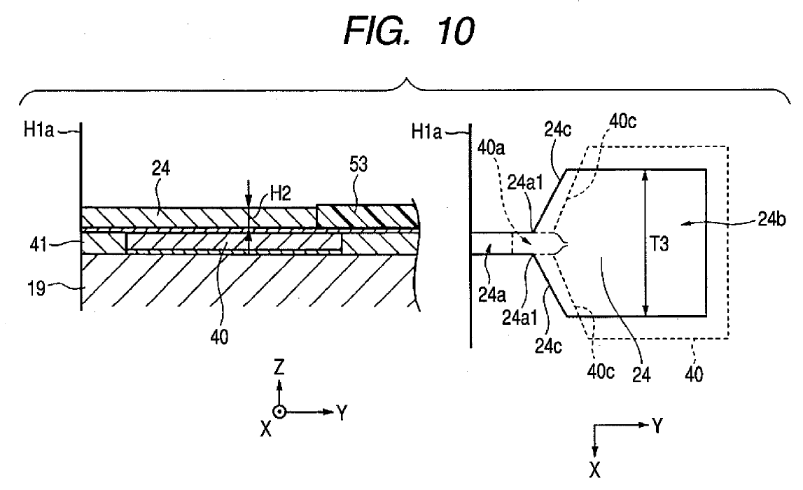

Next, in a process shown in FIG. 10, the coating base layer 52 exposed from the removal pattern 53a is coated with the main magnetic pole layer 24. After coating the main magnetic pole layer 24, the resist layer 53 is removed. It is preferable that the main magnetic pole layer 24 is formed of the magnetic material that has a saturation magnetic flux density higher than the sub-yoke layer 40. The magnetic pole front end portion 24a of the main magnetic pole layer 24 has an elongated shape of the track width Tw. Accordingly, when the main magnetic pole layer 24 is formed of a magnetic material having a low saturation magnetic flux density, the magnetic pole front end portion 24a is easily magnetically saturated, thereby deteriorating the recording performance. Accordingly, the main magnetic pole layer 24 is formed of the magnetic material that has a high saturation magnetic flux density. Meanwhile, since the sub-yoke front end portion 40a is provided even on the sub-yoke layer 40, the magnetic saturation easily occurs in the sub-yoke front end portion 40a. However, unlike the main magnetic pole layer 24, even if the sub-yoke front end portion 40a reaches the magnetic saturation, the sub-yoke rear end portion 40b of the sub-yoke layer 40 and the main magnetic pole layer 24 are partially overlapped with each other. Accordingly, the magnetic flux may be induced from the sub-yoke rear end portion 40b to the main magnetic pole layer 24, which is a problem in case of the main magnetic pole layer 24 does not occur. However, when the sub-yoke front end portion 40a reaches the magnetic saturation, the sub-yoke front end portion 40a loses a function of the sub-yoke front end portion 40a of directly supplying the sufficient magnetic flux to the magnetic pole front end portion 24a by approaching the opposite surface H1a as close as possible. Accordingly, it is preferable that the sub-yoke front end portion 40a is not magnetically saturated. In order to do so, it is preferable that the sub-yoke front end portion 40a does not reach the magnetic saturation by making a length in the height direction (Y direction shown in the drawing) of the sub-yoke front end portion 40a shorter than a length in the height direction of the magnetic pole front end portion 24a, or making the film thickness H1 of the sub-yoke layer 40 thicker than the film thickness H2 of the main magnetic pole layer 24 as described above, or making the length in the height direction (Y direction shown in the drawing) of the sub-yoke front end portion 40a shorter than the length in the height direction of the magnetic pole front end portion 24a and making the film thickness H1 of the sub-yoke layer 40 thicker than the film thickness H2 of the main magnetic pole layer 24.

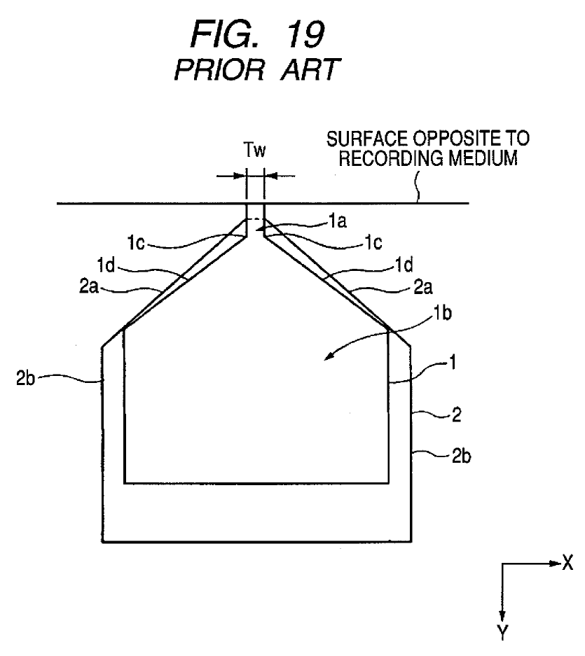

The main magnetic pole layer 24 is formed in the same shape as the removal pattern 53a by coating as shown in FIG. 2. That is to say, the main magnetic pole layer 24 includes an elongated magnetic pole front end portion 24a exposed to the opposite surface H1a by the track width Tw and extending in the height direction and the magnetic pole rear end portion 24b formed in the rear side of the height direction of the magnetic pole front end portion 24a and having a width T3 larger than the magnetic pole front end portion 24a. A distance between the trailing edge portion 24a1 of the magnetic pole front end portion 24a and the opposite surface H1a is the neck height NH. The neck height NH can be controlled by the main magnetic pole layer 24. Since the front end surface 40c of the sub-yoke rear end portion 40b of the sub-yoke layer 40 is positioned closer to the rear side of the height direction than the front end surface 24c of the magnetic pole rear end portion 24b of the main magnetic pole layer 24, it is possible to suppress the occurrence of the fringing from the sub-yoke layer 40. Further, since at least a part of the sub-yoke front end portion 40a is overlapped with the rear side of the magnetic pole front end portion 24a each other by disposing the sub-yoke front end portion 40a on the sub-yoke layer 40, it is possible to supply the sufficient magnetic flux from the sub-yoke layer 40 to the magnetic pole front end portion 24a of the main magnetic pole layer 24 and to increase the magnetic field intensity discharged from the magnetic pole front end portion 24a. Accordingly, it is possible to manufacture the perpendicular magnetic recording head having an excellent recording performance. The front end surface 40c of the sub-yoke rear end portion 40b of the sub-yoke layer 40 may be formed along the front end surface 24c of the magnetic pole rear end portion 24b of the main magnetic pole layer 24 in a plan view. Even when a part adjacent to the side end surface 40d of the front end surface 40c in the sub-yoke rear end portion 40b of the sub-yoke layer 40 is positioned closer to the opposite surface H1a than the front end surface 24c of the magnetic pole rear end portion 24b of the main magnetic pole layer 24, it is positioned apart from the main magnetic pole front end portion 24a in the track width direction. Accordingly, it is possible to suppress the occurrence of the fringing in comparison with the prior art shown in FIG. 19. However, it is preferable that the entire front end surface 40c of the sub-yoke rear end portion 40b of the sub-yoke layer 40 is positioned closer to the rear side of the height direction than the front end surface 24c of the magnetic pole rear end portion 24b of the main magnetic pole layer 24.

By the above-mentioned manufacturing method, the main magnetic pole layer 24 and the sub-yoke layer 40 is formed on the planarized surface by using a frame coating method or a pattern coating method and the neck height NH is controlled in the trailing edge portion 24a1 of the magnetic pole front end portion 24a of the main magnetic pole layer 24. By this configuration, it is possible to control the position of the neck height NH in high accuracy.

As described above, in the present embodiment, the main magnetic pole layer 24 and the sub-yoke layer 40 are separately formed without the trimming operation represented by the etching operation.

In the prior art, for example, the position of the neck height NH was determined by etching the main magnetic pole layer 24, but in a related case, since the deviation of the neck height NH easily occurred, it was difficult to determine the position of the neck height NH in high accuracy. Meanwhile, in the present embodiment, since the main magnetic pole layer 24 and the sub-yoke layer 40 are formed on the planarized surface by using the frame coating method or the pattern coating method as described above, it is possible to determine the position of the neck height NH in high accuracy. In the present embodiment, it is necessary to control a positional relationship between the trailing edge portion 24a1 of the main magnetic pole front end portion 24a and the trailing edge portion 40a1 of the sub-yoke front end portion 40a and a positional relationship among other parts so as to prevent the fringing and supply the sufficient magnetic flux to the main magnetic pole front end portion 24a of the main magnetic pole layer 24, but in the present embodiment, it is possible to easily perform the positional control by forming the main magnetic pole layer 24 and the sub-yoke layer 40 by using the frame coating method or the pattern coating method. That is to say, in the process shown in FIG. 9, the removal pattern 53a is formed on the resist layer 53 so as to form the main magnetic pole layer 24, but it is possible to form the main magnetic pole layer 24 in a predetermined shape or position without the trimming operation such as the etching operation by determining the shape and position of the removal pattern 53a in contract to the plane shape of the previously formed sub-yoke layer 40. Accordingly, by the method of manufacturing the perpendicular magnetic recording head of the present embodiment, since it is possible to control the position of the neck height in high accuracy and to control the positional relationship or the shape other than the neck height NH in high accuracy, it is possible to suppress the occurrence of the fringing and to or easily manufacture the perpendicular magnetic recording head a shape in which the magnetic flux can be sufficiently and smoothly induced into the magnetic pole front end portion 24a of the main magnetic pole layer 24.

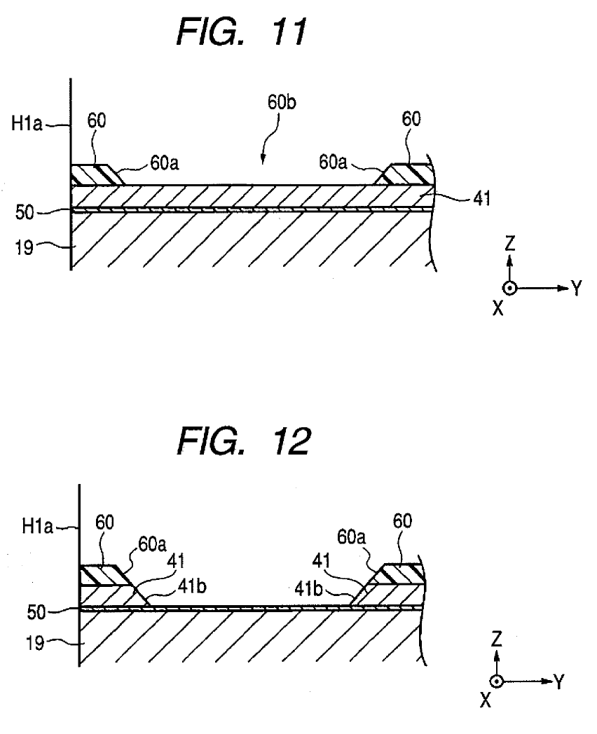

It is possible to stand all wall surfaces (including all of front end surfaces, rear end surfaces, and side end surfaces) of the main magnetic pole layer 24 and the sub-yoke layer 40 by forming the main magnetic pole layer 24 and the sub-yoke layer 40 by the frame coating method or the pattern coating method. Accordingly, it is possible to easily perform the positional control and to suppress the deterioration of the recording performance. However, as shown in FIG. 4B, the front end surface 40f of the sub-yoke layer 40 may be obliquely formed. For example, as shown in FIG. 11, the insulating layer 41 made of the inorganic insulating material such as Al₂O₃ or SiO₂ is formed on the coating base layer 50 in a predetermined film thickness and a resist layer 60 is applied onto the insulating layer 41 to form a removal pattern 60b having the same shape as the sub-yoke layer 40 on the resist layer 60 by the exposure phenomenon. Next, the resist layer 60 is extended by applying heat to the resist layer 60, thereby giving a slope to a wall surface 60a of the resist layer 60. As shown in FIG. 12, a part of the insulating layer 41 not covered with the resist layer is removed by the etching and the etching is ended when the coating base layer 50 is exposed. It is preferable to coat the coating base layer 50 thickly so as not to remove the entire coating base layer 50 by the etching.

As shown in FIG. 12, the shape of the wall surface 60a of the resist layer 60 is transferred onto a wall surface 41b of the insulating layer 41 becomes the inclined surface.

In a process shown in FIG. 12, when the coating base layer 50 is coated with the sub-yoke layer 40, the front end surface 40f of the sub-yoke layer 40 is formed in the slope slowly retreating in the height direction (Y direction shown in the drawing) as it goes from the top surface to the bottom surface as shown in FIG. 4B. Then, a planarizing operation is performed and the same processes as shown in FIGS. 8 to 10 are performed.

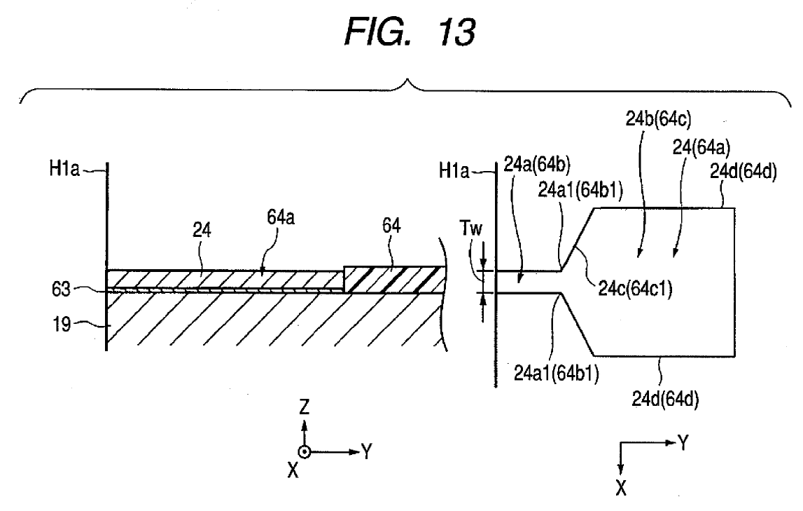

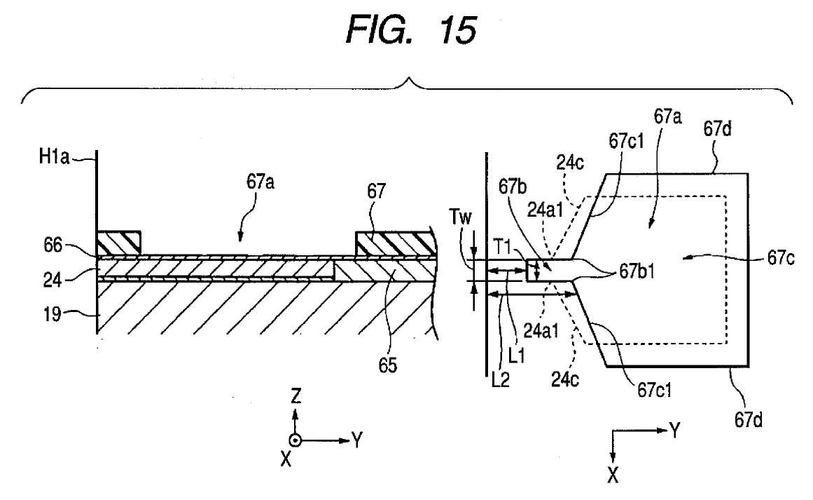

Next, each of process views shown in FIGS. 13 to 17 is one process view illustrating the method of manufacturing the main magnetic pole layer 24 and the sub-yoke layer 40 shown in FIG. 4C. Each figure is a partial cross-sectional view of the main magnetic pole layer 24 and the sub-yoke layer 40 during the manufacturing process. FIGS. 13 and 15 disclose the partial plan view at the right side of the partial cross-sectional view.

In a process shown in FIG. 13, a coating base layer 63 made of a NiFe is formed on the entire planarized surface of the insulating layer 19 by the sputtering method and a resist layer 64 is applied onto the entire surface on the coating base layer 63. Next, a removal pattern 64a of the main magnetic pole layer 24 is formed on the resist layer 64 by the exposure phenomenon. The removal pattern 64a is formed in the height direction (Y direction shown in the drawing) from the opposite surface H1a. Since the removal pattern 64a has the same shape as the main magnetic pole layer 24 shown in FIG. 2, an elongated front end portion 64b is formed in the removal pattern 64a and a rear end portion 64c having a width in the track width direction (X direction shown in the drawing) larger than the front end portion 64b is formed in the rear side of the height direction of the front end portion 64b as shown in the right figure of FIG. 13.

In the process shown in FIG. 13, when the removal pattern 64a is formed, the position of the trailing edge portion 64b1 of the front end portion 64b is controlled. The trailing edge portion 64b1 of the front end portion 64b is the position of the neck height at the time when the main magnetic pole layer 24 is formed next time. The width of the front end portion 64b of the removal pattern 64a is formed in high accuracy to be the track width Tw. The front end surface 64c1 facing the opposite surface H1a of the rear end portion 64c of the removal pattern 64a is formed in the slope slowly retreating in the height direction as it goes from the center of the width direction to the side end surface 64d.

Next, the coating base layer 63 exposed from the removal pattern 64a is coated with the main magnetic pole layer 24. By this configuration, the main magnetic pole layer 24 has the same shape as that of FIG. 2. That is to say, the main magnetic pole layer 24 includes the elongated magnetic pole front end portion 24a exposed to the opposite surface H1a by the track width Tw and extending in the height direction, and the magnetic pole rear end portion 24b that has a width larger than the magnetic pole front end portion 24a. The trailing edge portion 24a1 of the magnetic pole front end portion 24a is the position of the neck height NH. Accordingly, in the present embodiment, it is possible to control the position of the neck height NH with high accuracy.

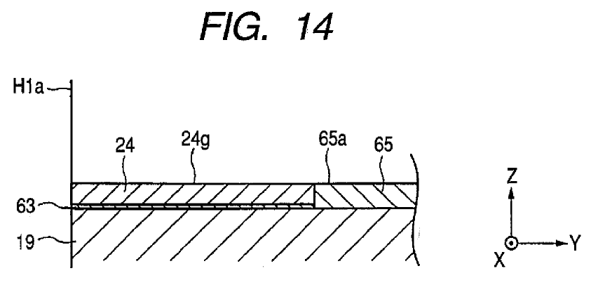

Next, the resist layer 64 is removed and the other coating base layer 63 below the main magnetic pole layer 24 is removed by the etching. Next, an insulating layer 65 made of the inorganic insulating material such as Al₂O₃ or SiO₂ is formed from the main magnetic pole layer 24 to the insulating layer 19 by the sputtering method. A top surface 24g of the main magnetic pole layer 24 and a top surface 65a of the insulating layer 65 are formed of the same planarized surface (see FIG. 14).

Next, in a process shown in FIG. 15, the entire surface on the main magnetic pole layer 24 and the insulating layer 65 is sputter-coated with a coating base layer 66 made of the magnetic material such as NiFe. Subsequently, a resist layer 67 is applied onto the entire surface on the coating base layer 66, and a removal pattern 67a of the sub-yoke layer 40 that has the same plane shape as FIG. 2 is formed on the resist layer 67 by the exposure phenomenon.

As shown in the right figure of FIG. 15, the removal pattern 67a is formed in the height direction from a position spaced apart in the height direction (Y direction shown in the drawing) from the opposite surface H1a by a predetermined distance L1. Since the removal pattern 67a has the same shape as the sub-yoke layer 40 shown in FIG. 2, an elongated front end portion 67b is formed in the removal pattern 67a and a rear end portion 67c having a width in the track width direction (X direction shown in the drawing) larger than the front end portion 67h is formed in the rear side of the height direction of the front end portion 67b as shown in FIG. 15. In the process shown in FIG. 15, when the removal pattern 51a is formed, the removal pattern 67a is formed apart in the height direction (Y direction shown in the drawing) from the opposite H1a by the distance L1 and the trailing edge portion 67b1 of the front end portion 67b of the removal pattern 67a is disposed at the same position as the trailing edge portion 24a1 of the magnetic pole front end portion 24a of the main magnetic pole layer 24 or at a position closer to the height direction than the trailing edge portion 24a1 in a plan view. The trailing edge portion 67b1 of the front end portion 67b is formed apart in the height direction from the opposite surface H1a by L2. At this time, it is preferable that the trailing edge portion 67b1 of the front end portion 67b of the removal pattern 67a is positioned closer to the height direction than the trailing edge portion 24a1 of the magnetic pole front end portion 24a of the main magnetic pole layer 24 since it is possible to easily determine the trailing edge portion 24a1 of the magnetic pole front end portion 24a as the position of the neck height NH. The width T1 of the front end portion 67b is equal to or smaller than the track width Tw of the magnetic pole front end portion 24a. At this time, the width T1 of the front end portion 67b is controlled to be smaller than the track width Tw, thereby easily adjusting the width. As shown in FIG. 15, the front end surface 67c1 facing the opposite surface H1a of the rear end portion 67c of the removal pattern 67a is formed in the slope slowly retreating in the height direction (Y direction shown in the drawing) from the center of the width direction to the side end surface 67d. However, at this time, the front end surface 67c1 is positioned closer to the height than the front end surface 24c of the magnetic pole rear end portion 24b of the main magnetic pole layer 24.

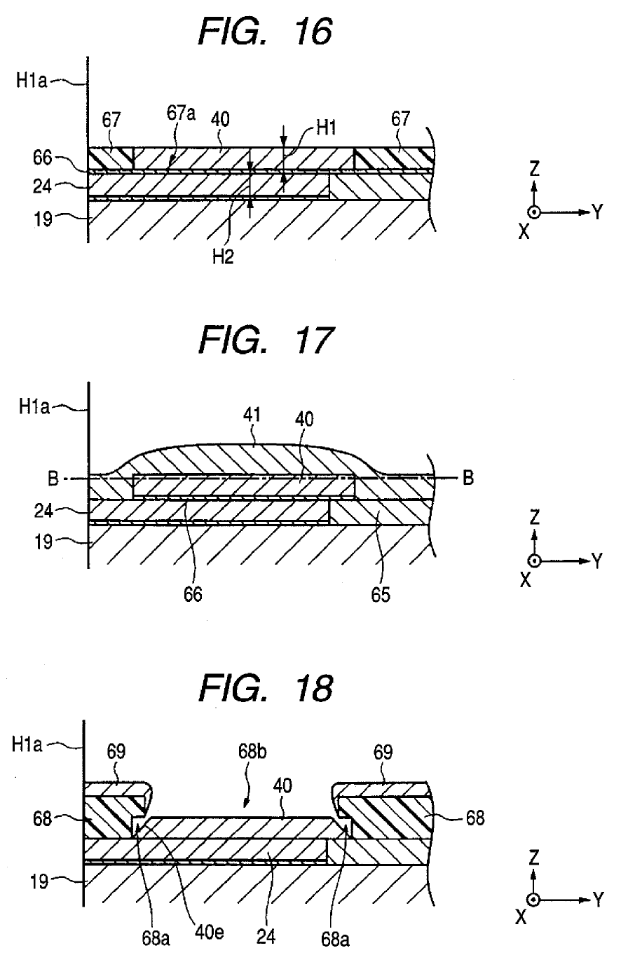

Next, in a process shown in FIG. 16, the coating base layer 66 exposed from the removal pattern 67a of the resist layer 67 is coated with the sub-yoke layer 40. It is preferable that the sub-yoke layer 40 is formed of the magnetic material that has a magnetic permeability higher than the main magnetic pole layer 24. It is preferable that the film thickness H1 of the sub-yoke layer 40 is formed in the film thickness H2 thicker than the main magnetic pole layer 24. Since the film thickness H1 of the sub-yoke layer 40 is decreased through a planarization process in a process of FIG. 17 rather than a coating operation in the process of FIG. 16, it is necessary to adjust the film thickness H1 in the coating step of FIG. 16 by anticipating the decreased film thickness. The sub-yoke layer 40 is formed in the same shape as the removal pattern 67a by coating as shown in FIG. 2. That is to say, as shown in FIG. 2, the sub-yoke layer 40 includes an elongated sub-yoke front end portion 40a extending in the height direction at a position spaced apart from the opposite surface H1a in the height direction, and a sub-yoke rear end portion 40b formed in the rear side of the height direction of the sub-yoke front end portion 40a and having a width T2 larger than the sub-yoke front end portion 40a. The trailing edge portion 40a1 of the sub-yoke front end portion 40a is formed at a position spaced in the height direction (Y direction shown in the drawing) from the opposite surface H1a by L2. The trailing edge portion 40a1 of the sub-yoke front end portion 40a is positioned closer to the height than the trailing edge portion 24a1 of the magnetic pole front end portion 24a of the main magnetic pole layer 24. Accordingly, it is possible to determine the neck height NH as the position of the trailing edge portion 24a1 of the magnetic pole front end portion 24a. The width T1 of the sub-yoke front end portion 40a is equal to or smaller than the track width Tw of the magnetic pole front end portion 24a of the main magnetic pole layer 24.

Subsequently, the resist layer 67 is removed and the other coating base layer 66 is removed by the etching.

Next, as shown in FIG. 17, The insulating layer 41 made of an inorganic insulating material such as Al₂O₃ or SiO₂ is formed of on the sub-yoke layer 40, the main magnetic pole layer 24, and the insulating layer 65 and the top surfaces of the sub-yoke layer 40 and the insulating layer 41 are planarized to a line B-B by using the CMP technology.

In the above description, the sub-yoke layer 40 is coated, but the sub-yoke layer 40 is formed with a lift-off resist layer 68 by the deposition method such as the sputtering method.

FIG. 18 is a partial cross-sectional view illustrating a manufacturing method of forming the sub-yoke layer 40 by the sputtering method. After the process of FIG. 14, the lift-off resist layer 68 is formed on the main magnetic pole layer 24 and the insulating layer 65. The removal pattern 68b which is not covered with the lift-off resist layer 68 is formed in the same shape as the sub-yoke layer 40. A concave portion 68a is formed adjacent to the bottom surface of the lift-off resist layer 68. As the result, by the sputtering method, when the sub-yoke layer 40 is coated, the concave 68a is difficult to coat and the front end surface 40e of the sub-yoke layer 40 is inclined about the height direction (Y direction shown in the drawing) as it goes from the top surface to the bottom surface as shown in FIG. 4D. When the sub-yoke layer 40 is coated, the top surface of the lift-off resist layer 68 is also coated with a magnetic material layer 69 made of the same material as the sub-yoke layer 40. The lift-off resist layer 68 is removed together with the magnetic material layer 69. Then, the process of FIG. 17 is performed.

By the manufacturing method shown in FIGS. 13 to 17, the main magnetic pole layer 24 and the sub-yoke layer 40 are formed on the planarzied surface by the frame coating method or the pattern coating method. In a process of FIG. 18, the sub-yoke layer 40 is formed of the lift-off resist layer 68 by the sputtering method.

As described above, in the present embodiment, the main magnetic pole layer 24 and the sub-yoke layer 40 each are formed without the trimming operation.

In the prior art, for example, the position of the neck height NH is determined by etching the main magnetic pole layer 24, but in the related case, since the deviation of the neck height NH easily occurred, it was difficult to determine the position of the neck height NH. Meanwhile, in the present embodiment, since the main magnetic pole layer 24 and the sub-yoke layer 40 is formed on the planarzied surface without the trimming operation, it is possible to determine the position of the neck height NH with high accuracy and to control the positional relationship or the shape other than the neck height in high accuracy. Accordingly, it is possible to suppress the occurrence of the fringing and to easily manufacture the perpendicular magnetic recording head having a shape in which the magnetic flux can be sufficiently and smoothly induced into the magnetic pole front end portion 24a of the main magnetic pole layer 24.

A size will be described. The distance L1 between the sub-yoke front end portion 40a of the sub-yoke layer 40 and the opposite surface H1a is preferably in the range of 0.01 to 3 μm. The distance (neck height NH) between the trailing edge portion 24a1 of the magnetic pole front end portion 24a of the main magnetic pole layer 24 and the opposite surface H1a is preferably in the range of 0.02 to 3 μm. The distance L2 between the trailing edge portion 40a1 of the sub-yoke front end portion 40a of the sub-yoke layer 40 and the opposite surface H1a is preferably in the range of 0.02 to 5 μm. The track width Tw is preferably in the range of 0.06 to 0.30 μm.

What is claimed is:

1. A method of manufacturing a perpendicular magnetic recording head, the method comprising the steps of:
(a) coating a sub-yoke layer on a planarzied surface, the sub-yoke layer having an elongated sub-yoke front end portion extending in a height direction from a position retreating from a surface opposite to a recording medium, and a sub-yoke rear end portion connected to a trailing edge portion of the sub-yoke front end portion and having a width in a track width direction larger than that of the sub-yoke front end portion;
(b) burying the periphery of the sub-yoke layer with an insulating layer and planarizing a top surface of the sub-yoke layer and a top surface of the insulating layer; and
(c) coating a main magnetic pole layer on the side-yoke layer and the insulating layer, the main magnetic pole layer having an elongated magnetic pole front end portion exposed to the surfaces by a track width Tw and extending in the height direction,
wherein the magnetic pole front end portion is overlapped with at least a part of the sub-yoke front end portion, and the width of the magnetic pole front end portion is equal to or larger than the width of the sub-yoke front end portion, and
wherein the trailing edge portion of the magnetic pole front end portion is disposed at the same position as the sub-yoke front end portion or disposed closer to the opposite surfaces than the trailing edge portion of the sub-yoke front end portion, whereby the neck height is controlled by the trailing edge portion of the magnetic pole front end portion.

2. The method of a perpendicular magnetic recording head according to claim 1, wherein in step (C), the entire front end surface facing the opposite surface of the magnetic pole rear end portion is formed along the front end surface facing the opposite surface of the sub-yoke rear end portion, and is formed closer to the opposite surface than the front end surface of the sub-yoke rear end portion.

3. The method of a perpendicular magnetic recording head according to claim 1, wherein the front end surface facing the opposite surface of the sub-yoke front end portion and the front end surface facing the opposite surface of the sub-yoke front end portion are formed in a slope inclined about the height direction from the top surface to a bottom surface, in step (a).

4. The method of manufacturing a perpendicular magnetic recording head according to claim 3, wherein prior to step (a), the insulating layer is formed at locations on the planarized surface other than the location where the sub-yoke layer is formed in step (a), and the rear end surface facing the front end surface of the sub-yoke front end portion on the insulating layer and the rear end surface that faces the front end surface of the sub-yoke rear end portion being formed in the slope inclined about the height direction from the top surface to the bottom surface, and
wherein a pattern surrounded with the insulating layer is coated with the sub-yoke layer in step (a) and only the planarizing operation is performed in step (b).

5. A method of a perpendicular magnetic recording head, the method comprising the steps of:
(d) coating a main magnetic pole layer on a planarized surface, the main magnetic pole layer having an elongated magnetic pole front end portion exposed to a surface opposite to a recording medium by a track width Tw and extending in a height direction, and a magnetic pole rear end portion connected to a trailing edge portion of the magnetic pole front end portion and having a width in a track width direction larger than that of the magnetic pole front end portion, wherein the neck height is controlled in accordance with the position of the trailing edge portion of the magnetic pole front end portion; and
(e) coating a sub-yoke layer on the main magnetic pole layer, the sub-yoke layer having an elongated sub-yoke front end portion extending in a height direction from a position retreating in the height direction from the opposite surface, and a sub-yoke rear end portion connected to the trailing edge portion of the sub-yoke front end portion and having a width in the track width direction larger than that of the sub-yoke front end portion,
wherein at least a part of the sub-yoke front end portion is overlapped with the magnetic pole front end portion, and the width of the sub-yoke front end portion is equal to or smaller than the width of the magnetic pole front end portion, and the trailing edge portion of the sub-yoke front end portion is disposed at the same position as the magnetic pole front end portion or disposed at a position retreating from the trailing edge portion of the magnetic pole front end portion in the height direction in a plan view.

6. The method of manufacturing a perpendicular magnetic recording head according to claim 5, wherein the sub-yoke layer is formed of a lift-off resist layer by a sputtering method in step (e).

7. The method of manufacturing a perpendicular magnetic recording head according to claim 6, wherein a front end surface facing the opposite surface of a sub-yoke front end portion and a front end surface facing the opposite surface of a sub-yoke rear end portion are formed in a slope inclined about a height direction as they go from a top surface to a bottom surface.

8. The method of manufacturing a perpendicular magnetic recording head, wherein an entire front end surface facing the opposite surface of the sub-yoke rear end portion is formed along the front end surface facing the opposite surface of the magnetic pole rear front end portion or by being retreated closer to the height than the front end surface of the magnetic pole rear end portion in a plan view, in step (e).

9. The method of manufacturing a perpendicular magnetic recording head according to claim 1, wherein the main magnetic pole layer is formed of a magnetic material having a saturation magnetic flux density higher than the sub-yoke layer, and the sub-yoke layer is formed of a magnetic material having a magnetic permeability higher than the main magnetic pole layer.
